(19) United States
(12) Patent Application Publication
(10) Pub. No.: US 2010/0213875 A1
(43) Pub. Date: Aug. 26, 2010

(54) Power Supply Controlling Device

(76) Inventor: Li-Chun LAI, Panciao City (TW)

Correspondence Address: HDLS IPR Services, PO Box 220746, Chantilly, VA, 20153, US

(21) Appl. No.: 12/393,198

(22) Filed: Feb. 26, 2009

(51) Int. Cl. H05B 41/36

(52) U.S. Cl. 315/307

(57) ABSTRACT

A power supply controlling device includes a main controlling unit, the main controlling unit stores daily sunrise and sunset time data from January 1^{st} to December 31^{st}; when the main controlling unit determines that the present time is the sunrise or sunset time, it controls a AC power supply to turn on or off a light automatically without human intervention to save energy.

### BACKGROUND OF THE INVENTION

1. Field of the Invention

The present invention relates to a power supply controlling device, and more particularly, to a power supply controlling device which determines whether to turn on or off a power supply according to daily sunrise or sunset times.

2. Description of the Prior Art

Generally, a traditional power supply controlling device uses an optical sensor or a timer for turning on the light when it's dark and turning off the light when it's bright to save energy.

However, the optical sensor or the timer can only turn on/off the light at specified times, they cannot precisely determine when the light should be turned on or off according to daily sunset and sunrise times and fail to provide the best energy saving capability.

Therefore, the traditional power supply controlling device still presents some shortcomings to be overcome.

In view of the above-described deficiencies of the traditional power supply controlling device, after years of constant efforts in research, the inventor of this invention has consequently developed and proposed an innovative power supply controlling device in the present invention.

### SUMMARY OF THE INVENTION

It is an object of the present invention to provide a power supply controlling device, which stores daily sunrise and sunset data from January 1st to December 31st in a main controlling unit for the main controlling unit to compare them with a present time; when the main controlling unit determines that the present time is the sunrise or sunset time, it controls a AC power supply to turn on or off a light automatically without human intervention to save energy.

In order to achieve the above object, the power supply controlling device comprises a rectifying and filtering circuit, a DC power supply generating circuit, a battery, a daylight saving time selector switch, a set of setup switches, a main controlling unit, an oscillator, a driving circuit, an LCD display, an LCD power supply circuit, a resetting circuit and a relay; when the rectifying and filtering circuit receives an AC power signal, it converts, rectifies and filters the AC power signal and transmits it to the DC power supply generating circuit; the DC power supply generating circuit can output various DC power signals having different voltages to the rechargeable battery and the driving circuit to charge the rechargeable battery so as to let the rechargeable battery provide a DC power signal to the main controlling unit; the main controlling unit stores daily sunrise and sunset data from January 1^{st} to December 31^{st}; the set of setup switches is provided for setting the time and the date data for storing in the main controlling unit and for displaying by the LCD display, wherein the date data comprises year/month/day, and the time data comprises hour/minute/second; the selector switch is provided for selecting whether to enter a daylight saving mode or not; the resetting circuit clears all the stored data; the oscillator provides an oscillating signal to the main controlling unit for the main controlling unit to operate normally; when the main controlling unit determines that the time and the date displayed by the LCD display match the stored sunrise or sunset time data and the date, it will transmit a signal to the driving circuit to drive the relay to control the output of the AC power source for turning on a light or other electrical appliances.

These features and advantages of the present invention will be fully understood and appreciated from the following detailed description of the accompanying Drawings.

### BRIEF DESCRIPTION OF THE DRAWINGS

FIG. 1 illustrates a block diagram of a power supply controlling device in the present invention;

FIGS. 2A, 2B illustrate circuit diagrams of the power supply controlling device in the present invention;

FIG. 3 illustrates a flow diagram of the power supply controlling device in the present invention;

FIG. 4 illustrates another flow diagram of the power supply controlling device in the present invention; and

FIG. 5 illustrates still another flow diagram of the power supply controlling device in the present invention.

### DETAILED DESCRIPTION OF THE PREFERRED EMBODIMENT

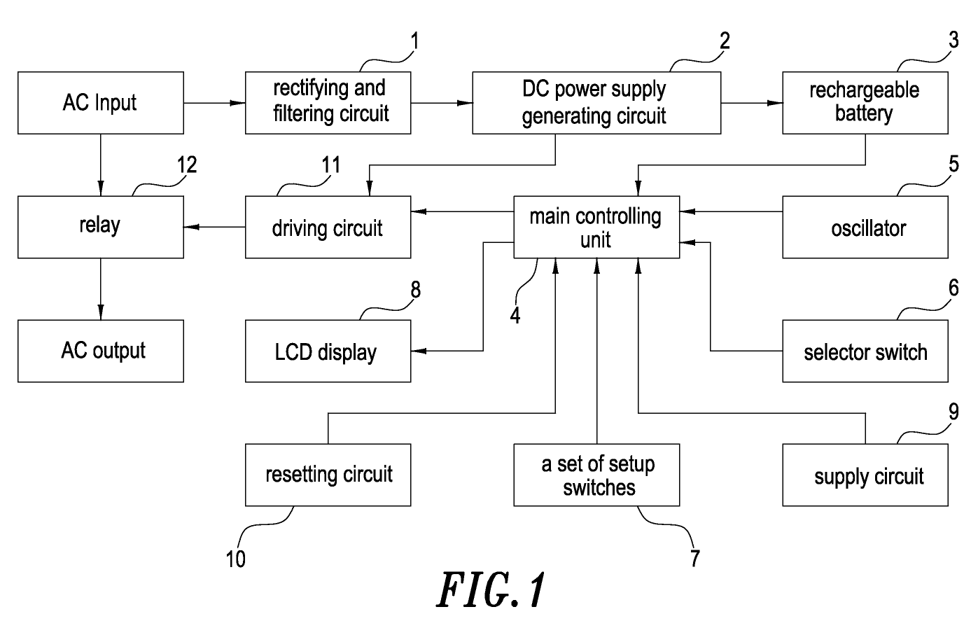

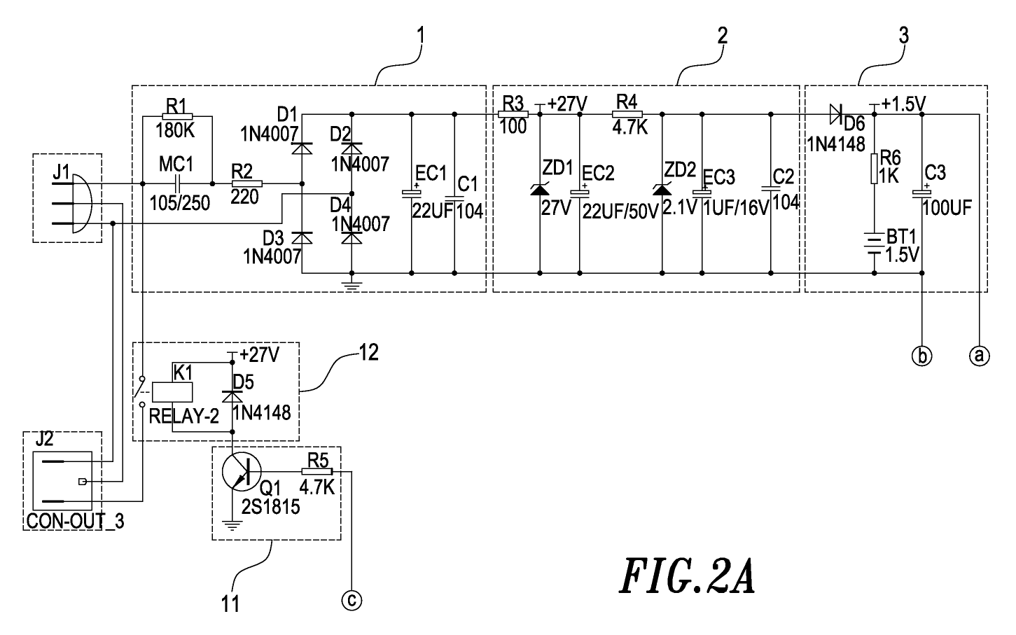

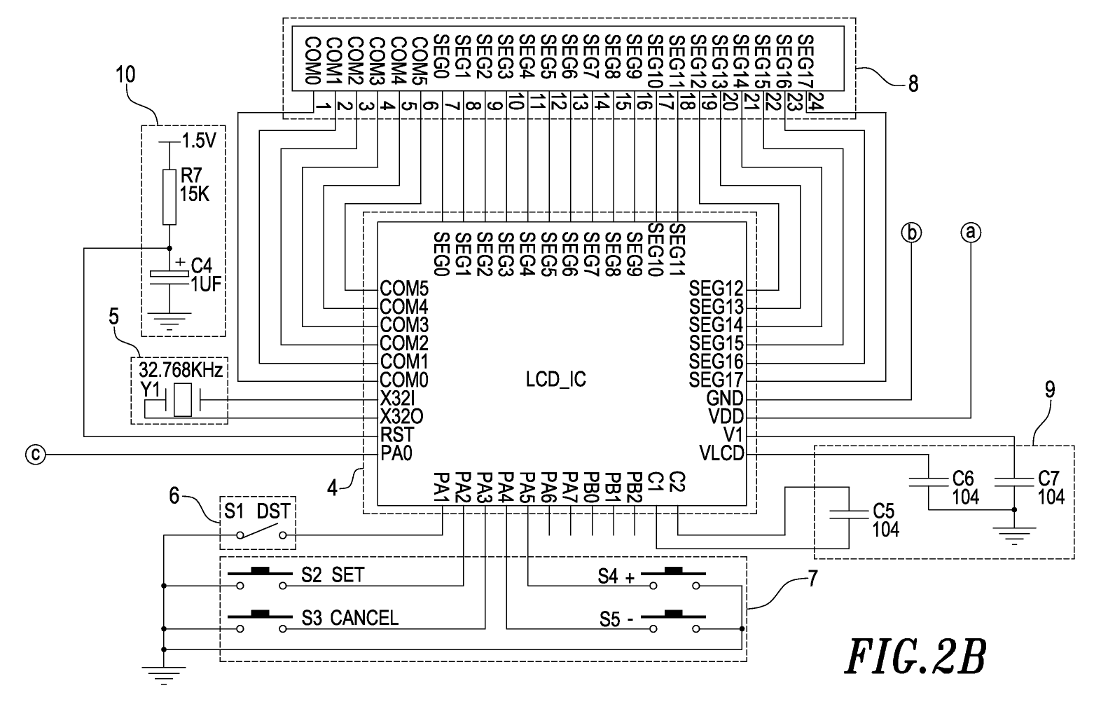

Please refer to FIG. 1, FIGS. 2A and 2B for a power supply controlling device disclosed in the present invention, which mainly comprises:

a rectifying and filtering circuit 1 for coupling with an AC power supply and then converting, filtering and rectifying an AC power signal and transmit it to a DC power supply generating circuit 2;

the DC power supply generating circuit 2 for receiving the AC power signal from the rectifying and filtering circuit 1, and then the DC power supply generating circuit 2 regulating and filtering the AC power signal to output various DC power signals having different voltages;

a rechargeable battery 3 for receiving the DC power signal from the DC power supply generating circuit 2 and providing a power signal to a main controlling unit 4;

the main controlling unit 4 for storing daily sunrise and sunset data from January 1^{st} to December 31^{st}; the daily sunrise and sunset data is based on an average of the data of the past ten to fifty years;

an oscillator 5 for providing an oscillating signal to the main controlling unit 4 to ensure normal operation of the main controlling unit;

a selector switch 6 for selecting whether to enter a daylight saving mode or not and sending a selection result to the main controlling unit 4;

a set of setup switches 7 coupled with the main controlling unit 4; when the set of setup switches is to set a time and a date, the main controlling unit 4 will drive the LCD display 8 to display the time and date data for comparison and to show the setting result; the LCD display 8 comprises a display interface which shows the data of year/month/date, hour/minute/second, advanced sunset time and delayed sunset time.
an LCD power supply circuit 9 for providing power to the LCD display 8 to let the LCD display 8 show the time correctly;

a resetting circuit 10 for clearing all stored data in the main controlling unit 4 when the main controlling unit 4 is disconnected from the DC power generating circuit 2;

a driving circuit 11 coupled with the DC power supply generating circuit 2; the driving circuit 11 is provided for driving a relay 12;

the relay 12 coupled with the AC power source; the relay 12 is provided for controlling an output of the AC power source;

when the main controlling unit 4 determines that the time and the date displayed by the LCD display 8 match the stored sunrise or sunset time data and the date, it will transmit a signal to the driving circuit 11 to drive the relay 12 to control the output of the AC power source.

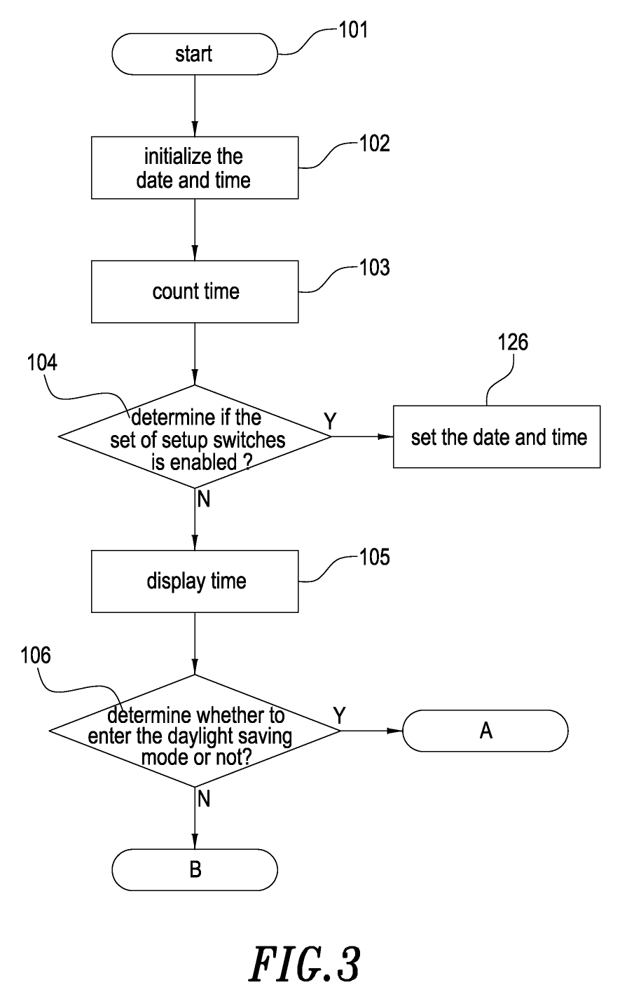

Furthermore, the node a in FIG. 2A is coupled with the node a in FIG. 2B, similarly, the node b, node c in FIG. 2A are coupled with the node b, node c in FIG. 2B respectively. Please refer to FIG. 3 for a flow diagram of the power supply controlling device in the present invention, when the main controlling unit starts in step 101, it begins with settings of year/month/day/hour/minute/second/half second/OFF (step 102); then starts to count the date and time (step 103); determines if the set of setup switches is enabled (step 104); if not, then shows the stored date and time via the LCD display (step 105); if the set of setup switches is enabled is enabled, then sets the data of year/month/date, hour/minute/second, advanced sunset time and delayed sunset time through the set of setup switches (step 126), and the setting result is also shown on the LCD display (step 105); afterwards, determines whether to enter the daylight saving mode or not (step 106), if so, then the process goes to step A, if not, then the process goes to step B.

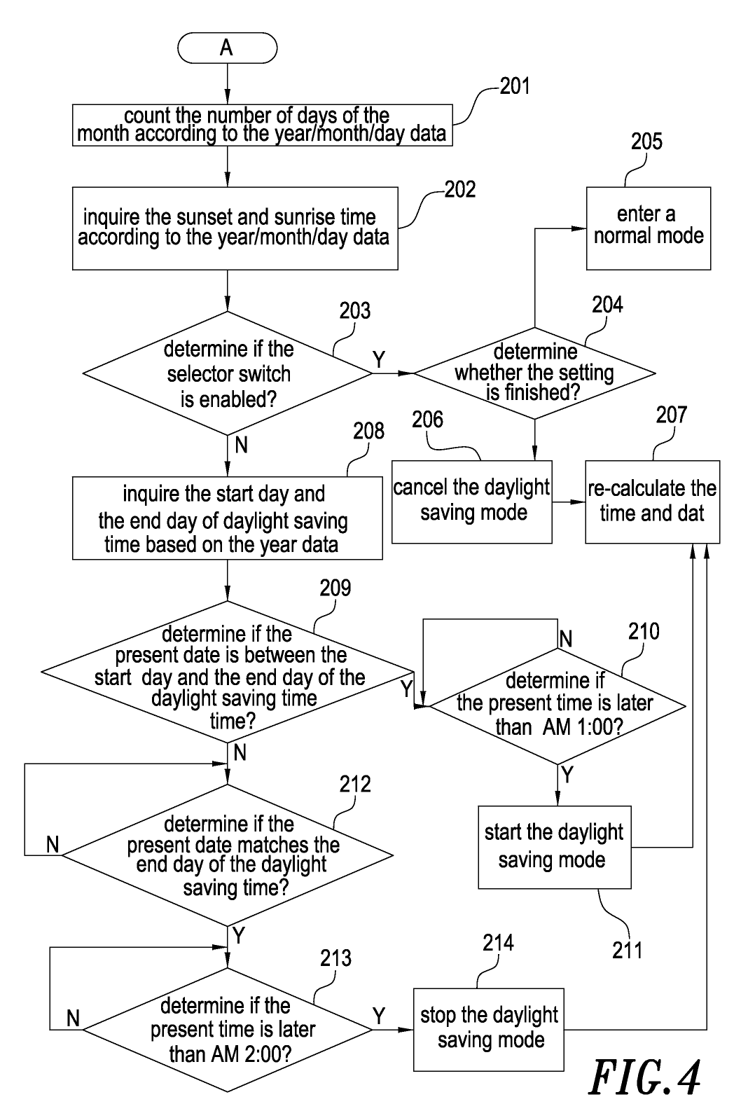

Please refer to FIG. 4 for a flow diagram illustrating the present invention entering the daylight saving mode, at the beginning, the main controlling unit counts the number of days of the month according to the year/month/day data (step 201); inquires the stored sunset and sunrise time in the main controlling unit according to the year/month/day data (step 202); then determines if the selector switch is enabled (step 203); if not, then determines whether the setting is finished (step 204), if not, then enters a normal mode (step 205), but if the setting is finished, cancels the daylight saving mode (step 206), and re-calculate the time and date (step 207), and enters the B step of a detecting mode; if the selector switch is enabled, inquires the start day and the end day of daylight saving time based on the year data (step 208), then determines if the present date is between the start day and the end day of the daylight saving time (step 209); if so, then determines if the present time is later than AM 1:00 (step 210), if yes, then starts the daylight saving mode (step 211) and re-calculate the time and date, for the sunrise and sunset time set to be one hour earlier (step 207); if the present time is not later than AM 1:00, then the step 210 continues; if the present date is later than the start day of the daylight saving time, then determines if the present date matches the end day of the daylight saving time (step 212), if not, the step 212 continues; if yes, then determines if the present time is later than AM 2:00 (step 213), if not, the step 213 continues; if yes, then stops the daylight saving mode (step 214) and re-calculate the time and date to restore the original sunrise and sunset time (step 207).

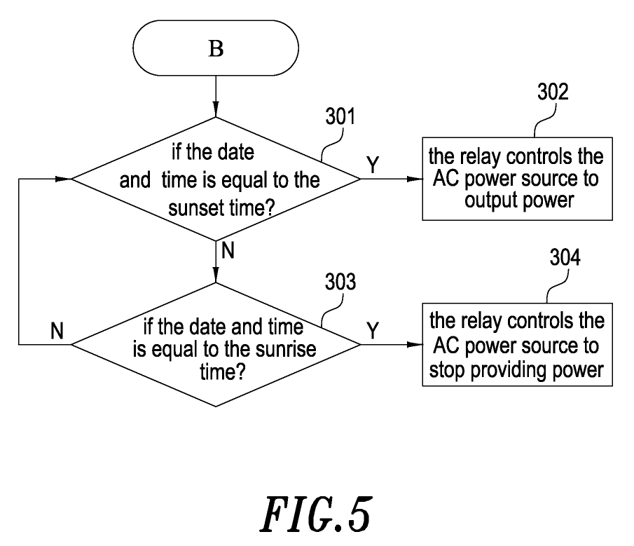

Please refer to FIG. 5, the present invention enter the detecting mode at step B. When the process starts, the main controlling unit determines if the date and time shown on the LCD display in the normal mode or the daylight saving mode is equal to the stored sunset time in the main controlling unit (step 301); if so, the main controlling unit drives the relay to control the output of the AC power source for turning on a light or other electrical appliances (step 302); if not, the main controlling unit determines if the date and time shown on the LCD display in the normal mode or the daylight saving mode is equal to the stored sunrise time in the main controlling unit (step 303); if so, then the main controlling unit drives the relay to control the output of the AC power source for turning off the light or other electrical appliances (step 304), if not, the step 303 continues.

Alternatively, the present invention can be set to stop providing power at sunset and start providing power at sunrise.

Besides, if it is in the daylight saving mode, the main controlling unit 4 uses the present time plus the daylight saving time (for example, one hour) to determine if the present time plus the daylight saving time matches the sunrise or sunset time, if so, then the main controlling unit 4 will drive the relay 12 to control the output of the AC power source.

The present invention discloses a power supply controlling device, while compared with prior art techniques, is advantageous in:

The present invention uses the main controlling unit to store daily sunrise and sunset time data from January 1st to December 31st for comparison, when the main controlling unit determines that the present time is the sunrise or sunset time, it controls an AC power supply to start supplying power or to stop providing power automatically without human intervention to save energy.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A power supply controlling device comprising:
a rectifying and filtering circuit for converting, filtering and rectifying an AC power source to output an AC power signal;
a DC power supply generating circuit for regulating and filtering the AC power signal to output various DC power signal having different voltages;
a rechargeable battery for receiving the DC power signal from the DC power supply generating circuit and providing a power signal to a main controlling unit;
the main controlling unit for storing daily sunrise and sunset data from January 1^{st} to December 31^{st};
an oscillator for providing an oscillating signal to the main controlling unit to ensure normal operation of the main controlling unit;
a set of setup switches coupled with the main controlling unit, the set of setup switches being provided for setting a time and a date to be displayed by an LCD display;
a driving circuit coupled with the DC power supply generating circuit, the driving circuit being provided for driving a relay;
the relay coupled with the AC power source, the relay being provided for controlling an output of the AC power source;
when the main controlling unit determines that the time and the date displayed by the LCD display match the stored sunrise or sunset time data and the date, it transmits a signal to the driving circuit to drive the relay to control the output of the AC power source.

2. The power supply controlling device as claimed in claim 1 further comprising a selector switch for selecting whether to enter a daylight saving mode or not and sending a selection result to the main controlling unit.

3. The power supply controlling device as claimed in claim 2, wherein the selector switch is turned on to indicate that the daylight saving mode is enabled, therefore the main controlling unit uses the present time plus the daylight saving mode to determine whether the sunset time or the sunrise time is reached.

4. The power supply controlling device as claimed in claim 1 further comprising an LCD power supply circuit for providing power to the LCD display to let the LCD display show the time correctly.

5. The power supply controlling device as claimed in claim 1 further comprising a resetting circuit for clearing all stored data in the main controlling unit when the main controlling unit is disconnected from the DC power generating circuit.

6. The power supply controlling device as claimed in claim 1, wherein the LCD display comprises a display interface which shows the data of year/month/date, hour/minute/second, advanced sunset time and delayed sunset time.
